(19) United States
(12) Patent Application Publication
(10) Pub. No.: US 2006/0184625 A1
(43) Pub. Date: Aug. 17, 2006

(54) Short query-based system and method for content searching

(76) Inventors: Markus A. Nordvik, San Francisco, CA (US); Zaw L. Thet, San Francisco, CA (US); Michael S. Stachowiak, San Francisco, CA (US)

Correspondence Address: PILLSBURY WINTHROP SHAW PITTMAN LLP, P.O. BOX 10500, MCLEAN, VA, 22102, US

(21) Appl. No.: 11/345,610

(22) Filed: Jan. 31, 2006

Related U.S. Application Data
(60) Provisional application No. 60/648,959, filed on Jan. 31, 2005.
(60) Provisional application No. 60/648,731, filed on Jan. 31, 2005.
(60) Provisional application No. 60/648,733, filed on Jan. 31, 2005.

(51) Int. Cl. G06F 15/16

(52) U.S. Cl. 709/204; 707/2; 707/3

(57) ABSTRACT

Embodiments of the invention provide systems and methods for processing queries provided as short messages. Keywords can be extracted from short messages and specific meaning can be derived and attributed to the short messages based on various attributes and context associated with the message, time of day and a user. Responses are provided that comprise content from information sources identified as best-fit search result. Responses are provided that comprise a menu having options identifying plural high probability search results. An alert system is disclosed for generating and managing alerts based on search results. Based on search results, a user can be connected to an information service or a transactional system and can be provided with advertising, marketing and help information.

### RELATED APPLICATIONS

The present application claims priority from provisional patent application No. 60/648,959 entitled “Short Query-based System and Method for Content Searching,” filed Jan. 31, 2005, and from provisional patent application No. 60/648,731 entitled “Prioritization of Search Responses System and Method,” filed Jan. 31, 2005, and from provisional patent application No. 60/648,733 entitled “Automated Transfer of Data from PC Clients,” filed Jan. 31, 2005, which provisional applications are incorporated herein by reference and for all purposes.

### BACKGROUND OF THE INVENTION

1. Field of the Invention

The present invention generally relates to information searching techniques. More particularly, the present invention relates to the provision of access to information using communications devices with limited capabilities.

2. Description of Related Art

Information searching generally operates by parsing alphanumeric data to retrieve phrases, terms and words for searching. Often, a single alphanumeric string returns results that include large numbers of potential matches. In practice, many—often a majority—of the results are not relevant, duplicative or otherwise invalid. The quality of results often depends on the search string provided and usually requires detailed and focused terms.

Most search engines use a parser to extract search terms and generate a result. Simply put, the purpose of parsing a string is to extract a meaning from the string. While relatively easy for a human to understand, a computer does not have the same vocabulary or ability to fit the meanings of words together. Many search engines today have not been required to perform complex parsing because users are forced to enter specific types of queries in separate boxes. For example, in locating a retail store, a search engine usually provides an input box for a home address separate from an input box for a type of retail store sought. With the advent of widespread mobile communications, limited input is available and, in many current systems, such as a text messaging medium, only one input box may be available and only limited interaction is possible. Thus the degree of difficulty of creating a useful search string increases exponentially, resulting in low quality results for mobile devices with limited input capability.

### SUMMARY OF THE INVENTION

The present invention addresses problems associated with prior art search methods. The present invention provides systems and methods for delivering targeted information in response to search queries or other requests. The systems and methods permit users to qualify, expand, and tune an initial query and to sort and prioritize results. The systems and methods also permit the user to request specific types of information or actions.

The present invention provides users with a method for setting alerts triggered by specific types of information, wherein the alerts may be based on results obtained from prior queries. The system and method also provides a transaction gateway using Short Message Service (“SMS”), Multimedia Messaging Service (“MMS”), or Interactive Voice Response (“IVR”) to purchase items. Embodiments of the present invention dynamically create new grammar and lexicons for subsequent usage.

In some embodiments of the invention user profiles are built, wherein the profiles are based on usage and other system information. This profile information and other information contained within the system can be combined and used to generate relevant advertising results or sponsors.

The present invention also provides a variety of user interfaces including web browser, automated telephone response systems, Email and SMS/MMS based systems. Embodiments of the present invention may be configured for use in wireless communication systems, Internet and other suitable communications media.

### BRIEF DESCRIPTION OF THE DRAWINGS

These and other aspects of an embodiment of the present invention are better understood by reading the following detailed description of the preferred embodiment, taken in conjunction with the accompanying drawings, in which:

FIG. 1 is a drawing showing an embodiment of the present invention;

FIG. 2 is a flowchart diagramming how an embodiment can be used over a wireless communications medium;

FIG. 3 is a drawing showing an overview structure of an embodiment of the invention;

FIG. 4 is a drawing showing the structure of a gateway as provided in embodiments of the invention;

FIG. 5 is a flowchart describing the operation a gateway according to aspects of the present invention;

FIG. 6 is a flow diagram illustrating a query portion as provided in one embodiment;

FIG. 7 is a flow diagram showing examples of preprocessing and response formatting;

FIG. 8 is a block diagram depicting a pre-processing portion of an embodiment;

FIG. 9 is a flow diagram illustrating the construction of user profiles;

FIG. 10 is a table to the types of user profile information that can be generated by embodiments of the present invention and its uses;

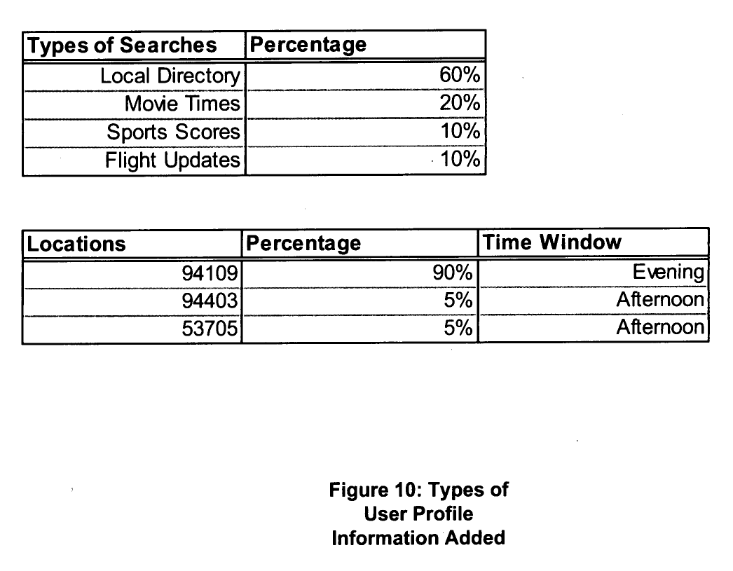

FIG. 11 is a flow diagram illustrating the end user experience for a movie query;

FIG. 12 is a flow diagram illustrating the end user experience for a travel-related query;

FIG. 13 is a flow diagram illustrating the end user experience for a sports query;

FIG. 14 is a flow diagram illustrating the end user experience for a city lookup query;

FIG. 15 is a flow diagram illustrating the end user experience for a nightlife query;

FIG. 16 is a flow diagram illustrating the end user experience when replying to targeted advertising in search results; and

FIG. 17 is a flow diagram illustrating the end user experience for a search for specific company information and interactivity by keyword.

### DETAILED DESCRIPTION OF THE INVENTION

The present invention will now be described in detail with reference to the drawings, which are provided as illustrative examples of the invention so as to enable those skilled in the art to practice the invention. Notably, the figures and examples below are not meant to limit the scope of the present invention. Where certain elements of the present invention can be partially or fully implemented using known components, only those portions of such known components that are necessary for an understanding of the present invention will be described, and detailed descriptions of other portions of such known components will be omitted so as not to obscure the invention. Further, the present invention encompasses present and future known equivalents to the known components referred to herein by way of illustration.

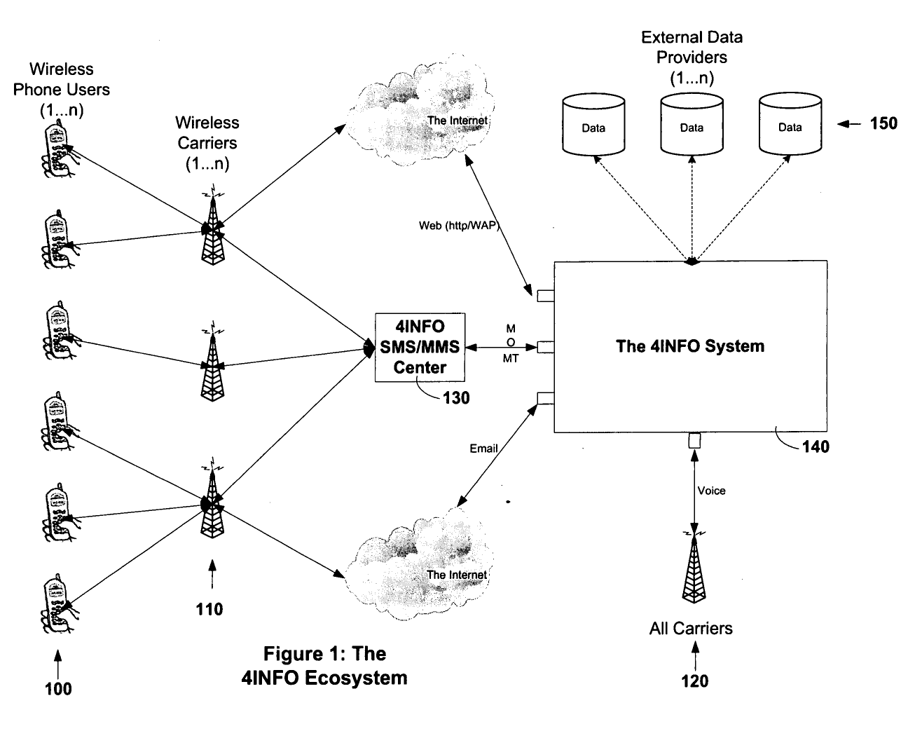

Referring to FIG. 1, certain embodiments of the invention provide a system (hereinafter the 4INFO System) that can interact with a variety of different communications media. Many embodiments of the system provide access to Wireless Phone Users 100 over Wireless Carriers 110 via the Internet, SMS/MMS, or voice-based systems. Certain embodiments may additionally provide an SMS/MMS Center 130 implemented using a customized or standard SMS/MMS broker. External Data Providers 150 may be used to provide relevant information to users. The relevant information is typically routed through the SMS/MMS center 130 or, in at least some embodiments, through the World Wide Web, Email, or Voice channels.

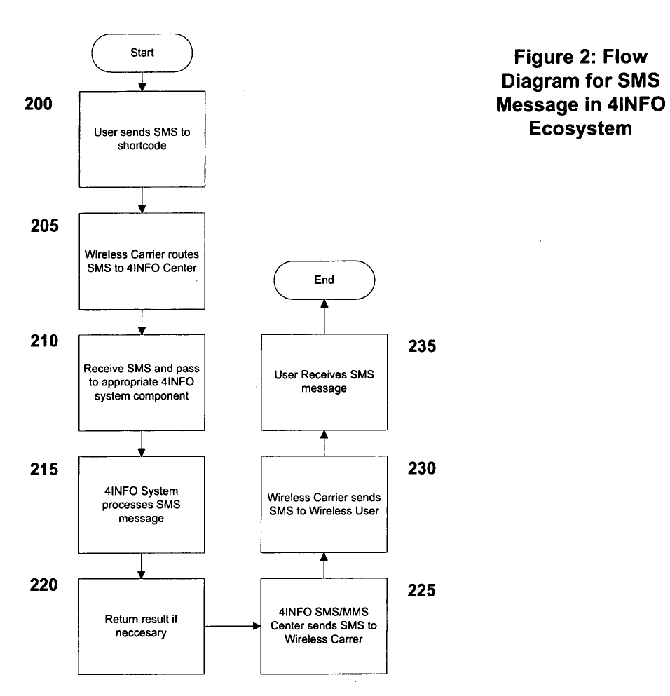

Referring now to FIG. 2, a typical transaction of the embodiment depicted in FIG. 1 is presented. In the example, a user typically uses SMS for sending and receiving messages to and from the 4INFO System. At Step 200, the user composes an SMS text message and transmits the text message to a number associated with the 4INFO System. For example, a shortcode number (such as 44636) is used in the example. It will be appreciated that a shortcode is defined in this example to be a 5-digit number that is provided by an independent cellular governing body. Next, the text message is routed at step 205 by the user's wireless carrier to the SMS/MMS Center 130. The SMS/MMS Center 130 serves as a hub between various wireless services providers and the 4INFO System and typically, all wireless traffic is routed through the SMS/MMS Center 130. In the example depicted, the SMS/MMS Center 130 then transmits the SMS message to the 4INFO System at step 210, along with one or more identifying attributes about the incoming message. The identifying attributes can include a telephone number, carrier type, and handset identification, where known. The 4INFO System processes the incoming SMS message at step 215 and returns any required response through the SMS/MMS Center 130 at step 220. The SMS/MMS Center 130 may return a response in essentially the same manner as the incoming text message, routing the SMS message to an appropriate wireless service provider at step 225. At step 230, the service provider sends the response through the service provider network to a designated wireless user. At step 235, the wireless user typically receives the response on a cell phone.

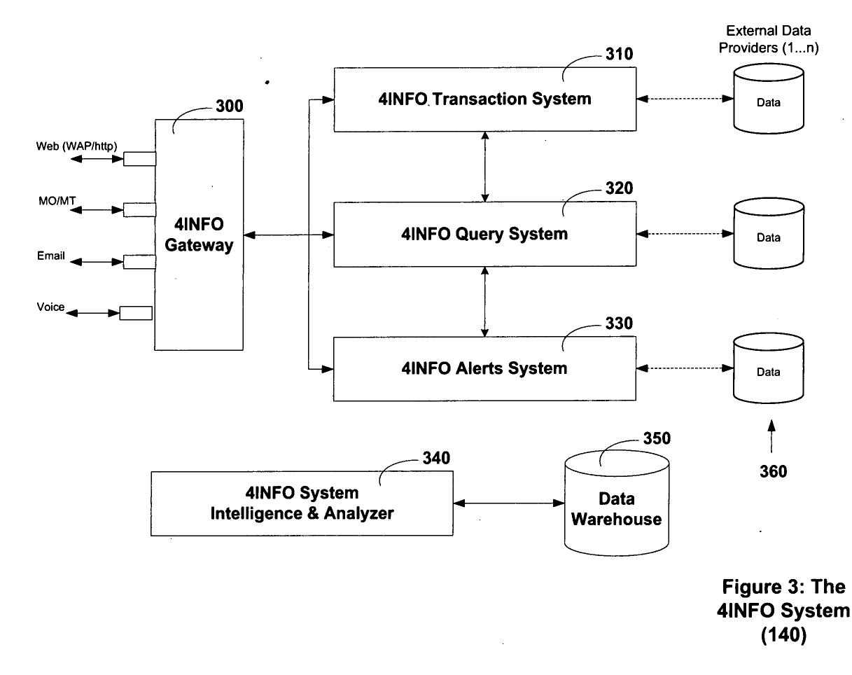

Referring now to FIG. 3, in certain embodiments, a typical 4INFO System comprises a gateway 300, a transaction system 310, a query system 320, an alert system 330, a system intelligence and analyzer component (hereinafter “the analyzer”) 340 and a data warehouse 350. The 4INFO System may typically used to provide communication with various devices and systems external to the 4INFO System. The gateway 300 may use any appropriate communications method including SMS/MMS based methods. The transaction system 310 typically provides transactional services including credit card processing, interactive voice response system, and WAP based services. The transaction system 310 may provide these services using one or more external service providers (shown generally at 360). In at least some embodiments, the type of service provided depends on user-related factors including a user profile, prior activity and so on. The query system 320 is typically used for processing queries and searching and delivering information from various static and real-time information database sources. The query system 320 may also interact with the external data providers 360.

The alerts system 330 typically provides for scheduling, generation and transmission of alerts containing a combination of real-time and preconfigured information for end users. The alerts system 330 may also communicate with the external data providers 360 and the query system 320. The analyzer 340 is typically maintained as a separate component and may operate independently of the real-time transactions. The analyzer 340 may interact with the internal data warehouse 350 to supplement and enhance internal lexicons, grammars, aliases, user profiles, and other system specific information. It will be appreciated that the supplementation and enhancement provided by the analyzer 340 may also affect other major components of the 4INFO System. In certain embodiments of the system, the analyzer 340 builds additional information based on past user behavior using a plurality of tools and combinations of tools including machine learning and probability engines. The internal data warehouse 350 is typically constructed from disparate system data components including one or more user databases, transaction databases, and other such information sources as described below.

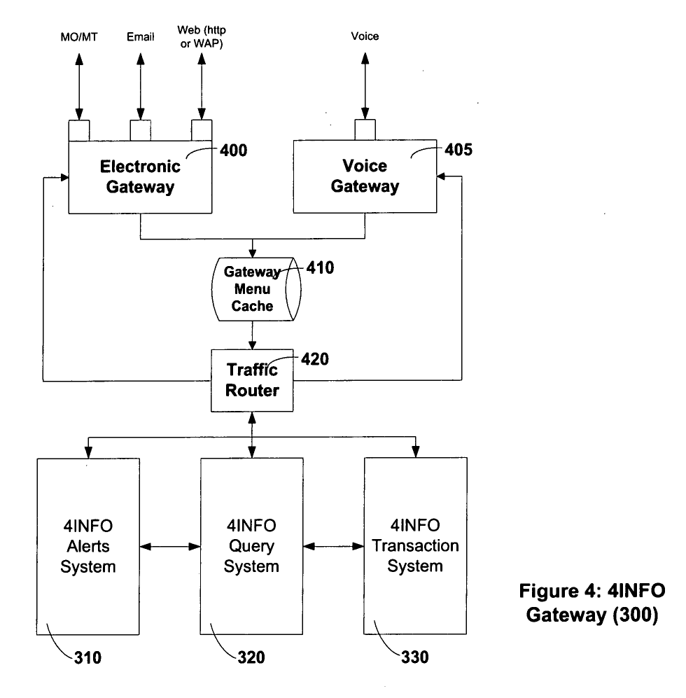

Referring now to FIG. 4 together with FIG. 3, an example of an embodiment of the gateway 300 is provided in FIG. 4. The gateway 300 is typically used for routing different types of traffic to appropriate internal components. In the example provided, an electronic gateway 400 connects the 4INFO System using various common protocols including MO/MT, Email and Web protocols. The electronic gateway 400 can also manage the queuing of messages that are received and sent through the system and may additionally manage any connectivity issues associated with the SMS/MMS center or generic provider of such services. A voice gateway 405 is typically used to support voice transactions, handling both outgoing and incoming voice transactions. The electronic gateway 400 and the voice gateway 405 may also append additional information to the user object when the object enters the system. For example, where the transaction involves an incoming Mobile Originated SMS Message (MO), the wireless carrier of the user and the phone number are added to the object that is sent through the system.

In some embodiments, a gateway menu cache 410 stores information related to a user's prior interactions with the system. For example, where a user, in a first SMS message, is offered an option of connecting with an interactive voice response (“IVR”) system, the gateway menu cache 410 may record alert may be transmitted to the transaction system 310 indicating that the transaction system 310 should initiate a voice call the user. A traffic router 420 is typically provided to permit both the electronic gateway 400 and the voice gateway 405 to communicate with any of the major components of the 4INFO System. Thus, the transaction system 310, the query system 320 and the alerts system 330 may be accessed through the traffic router 420.

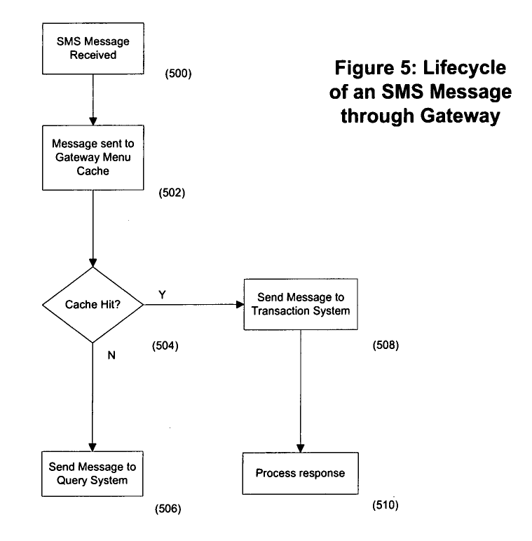

Referring now to FIGS. 3-5, the flowchart of FIG. 5 illustrates an example of routing an incoming SMS message through the gateway 300. At step 500 in this example, an incoming SMS message is received by the electronic gateway 400 and is transmitted to the gateway menu cache 410 at step 502. At step 504, the gateway menu cache 410 detects that the SMS message is a response from a user to a request to purchase movie tickets. Instead of passing the SMS message to the query system 320 at step 506 (as would normally be done), the gateway menu cache 410 causes a message to be sent through the traffic router 420 to the transaction system 310 at step 508. The transaction system 310 then may initiate either a voice call to the user or create another SMS message for transmitting additional purchase information to the user at step 510. Messages and voice calls created in this manner are typically routed through the traffic router 420 to an appropriate gateway. In the case of an SMS message the appropriate gateway may be the electronic gateway 400. In the case of a voice call the appropriate gateway is typically the voice gateway 405.

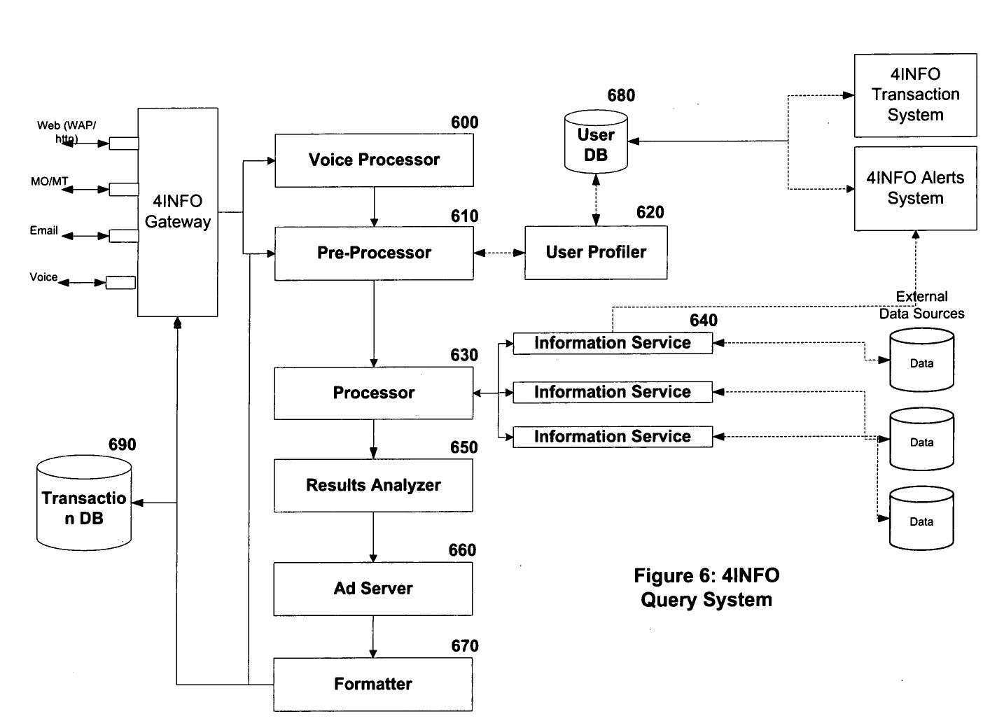

Referring to FIG. 6 together with FIG. 3, another embodiment illustrates an example of the function of the query system 320 and associated interactions between external users and internal system components. This query system, consistent with the invention, provides search results in response to an alphanumeric query. In certain embodiments, the query system includes a voice processor 500 to receive voice-based queries and to provide voice-based responses. In the example, the query system also includes a pre-processor 510, a main processor 530, a results analyzer 550 an ad server 560 and a response formatter 570. Additionally, a user profiler 580 maintains user profiles in a database 580 and a plurality of information services 540 may be used to provide access to external data sources.

In certain embodiments, formatter 570 operates to provide responses consistent with capabilities and limitations of end user devices. For example, the character limit for text messages varies widely based on the wireless carrier and the type of phone. The formatter 570 dynamically creates responses based on a user's carrier and phone as follows. First, the user's carrier identity is automatically detected upon receipt of an incoming message (for example, a Nextel user would receive a 512 character message while Sprint users would only be allowed 160 characters). Additionally, upon user registration on a website provided in many embodiments of the invention, additional information on phone model and service may be obtained, including, for example, information for determining whether to send MMS or SMS messages.

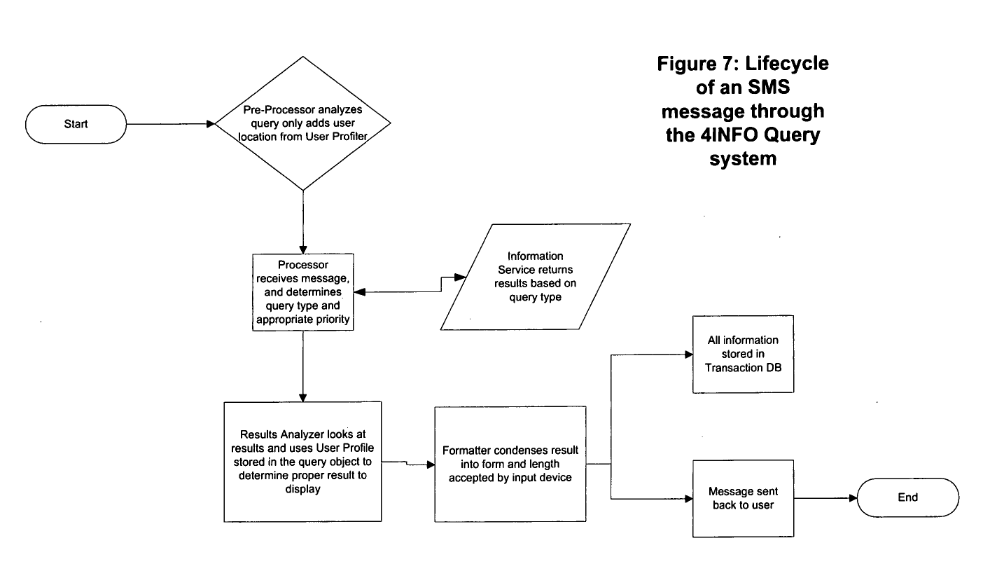

The query system also provides for the delivery of concise information via SMS. In various embodiments an English-to-SMS translator is provided that converts English language words, phrases, terms, abbreviations, etc., to create a shorter format readable by components of the 4INFO System. For example, in the example of a weather forecast, word “2nite” can be substituted and transmitted in place of the word “tonight.” This translator can be configured to operate bi-directionally such that a user query with the word “2nite” can be interpreted as a request for tonight's weather. FIG. 7 provides a flowchart showing both

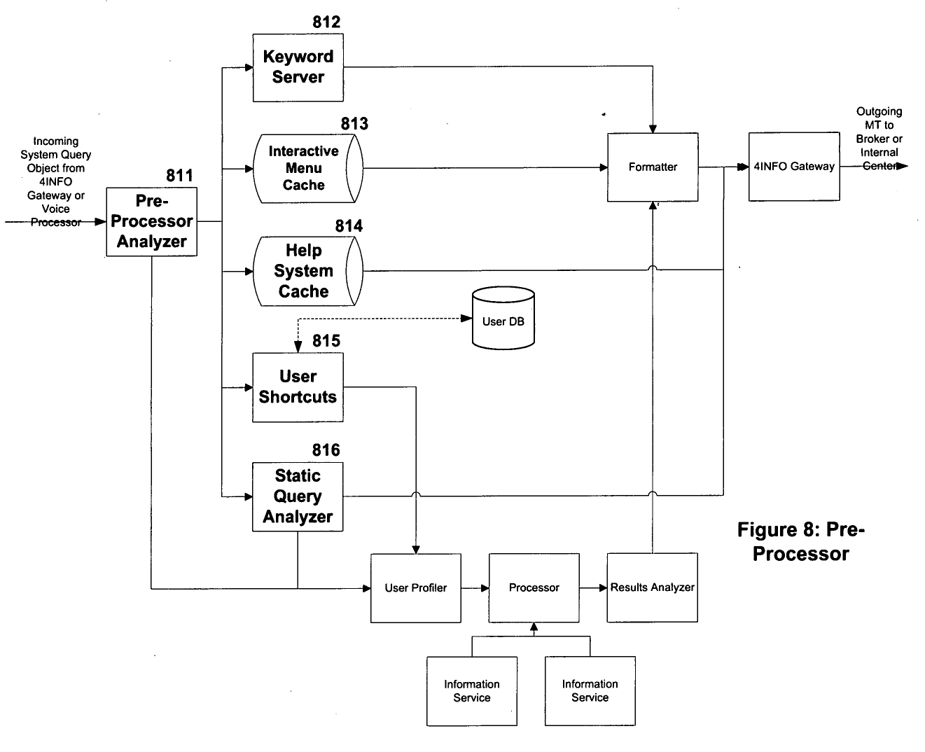

Referring now to FIG. 8, in certain embodiments, a preprocessor provides a capability in many embodiments to return rapid responses to alphanumeric search queries without further processing. A keyword server 812 typically stores types of words that users may enter for triggering a specific type of interaction. Keyword server 812 can include one or more company-specific menus and sets of interactions and data relating to specific service providers (such as FedEx). An interactive menu cache 813 may be provided to store information related to a history of prior interactions between a user and the system. This information may be used to facilitate anticipation and interpretation of future queries. The help system cache 814 is provided to present users with specific help messages. User shortcuts 515 are typically provided as alphanumeric characters that have a specific meaning. The specific meaning may be derived from information related to the user, location and history of queries by the user. A user may create predefined shortcuts. In at least some embodiments, the 4INFO System may automatically suggest or define shortcuts. Shortcuts may also be adopted from common usage. Definition of shortcuts may be made locally or through a 4INFO or other website or by using some other web property. In one example of shortcut creation, a user may register the letter ‘h’ as a home address. In any future interaction the word ‘h’ would be interpreted as the user's home address and this information would be added to the query object to provide more accurate system results.

Finally, a static query analyzer 816 can take a user's query and translate it into a different system query. For example, the user could send a query such as “this is funny” that would be translated into a search for “comedy clubs” in the user's area code or standard location as defined by the user profile and users access to an interactive response system with a variety of different options. The depth of interactivity is made possible by stored session state information and a results probability engine. Examples of the types of interactions that the interactive menu cache stores include:
i) Choose an option within a service (i.e. select movie theatres from a list)
ii) Request additional information about a result (i.e. team scoring summary, stock price 52 week high, amazon.com product info, advertisement, etc.)
iii) Show multiple service results for unclear queries (i.e. ray san francisco, taxi 53705—can both be interpreted as a movie query and a directory query)
iv) Give results for service ambiguous queries (san francisco)
v) Set an alert for something (united 1344)
vi) Reply back with an addition to their query (i.e. reply back with zip code for show times for a movie)

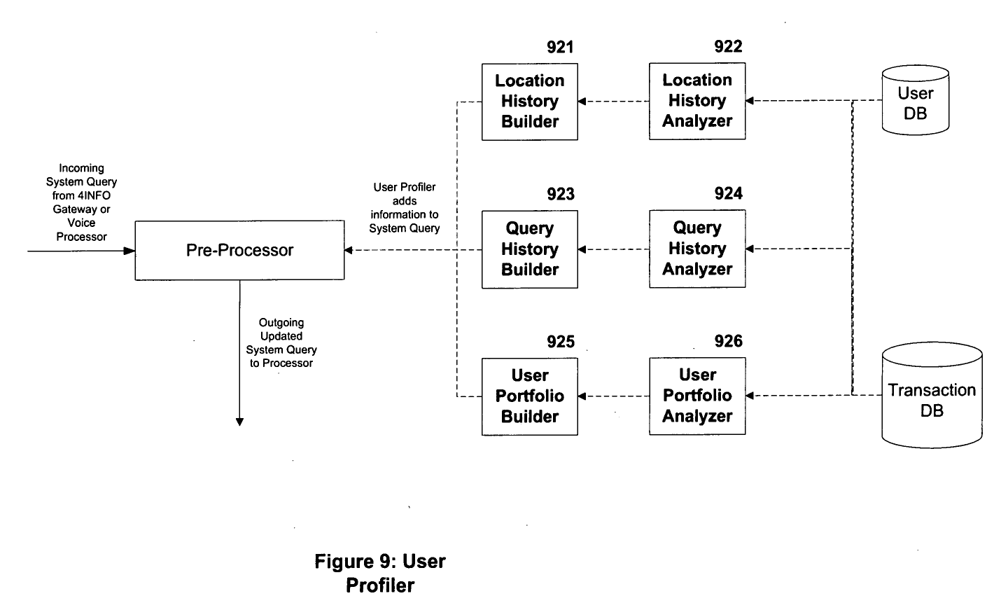

Referring to FIG. 9, certain embodiments of the invention provide a user profiler for building information concerning user location and service preferences. Where a requested service requires a parameter of location to be satisfied, and yet no location information or ambiguous location information is provided by the user, a heuristic system is used to make a best guess as to which location they intended to use. For example, when a user enters the word “pizza” with no location identifier, or the word “pizza” and the city “pasadena” with no state information, the system may use the heuristic to obtain a best guess regarding the user's preferred location. The heuristic typically relies on user profile and other user-related information to obtain a location profile associated with the user. This location profile may be developed using the user's search history, phone area code, and other factors. Also, on the first occasion that location information is selected by heuristic, the user may be provided with information necessary to reverse the behavior or store a preferred location for future use.

The transaction system can also interact with external users and internal system components. The transaction system can act as a billing gateway and may be used to permit users to purchase products or services via voice, web, or SMS.

An alerts system is provided to create and generate information alerts for users. The alerts system is typically responsible for the creation, storage, and generation of both status change and periodic alerts. Included in the alerts system is a system for news alerts whereby users may enroll via telephone or web for alerts on pre-defined categories or specific keywords. It will be appreciated that the introduction of keyword triggers in the provision of mobile news alert systems provides an advantage over previous wireless news services. The alerts system of the present invention typically returns a news alert that not only gives the title of the article, but also the part of the content of the article that actually references the user set keyword.

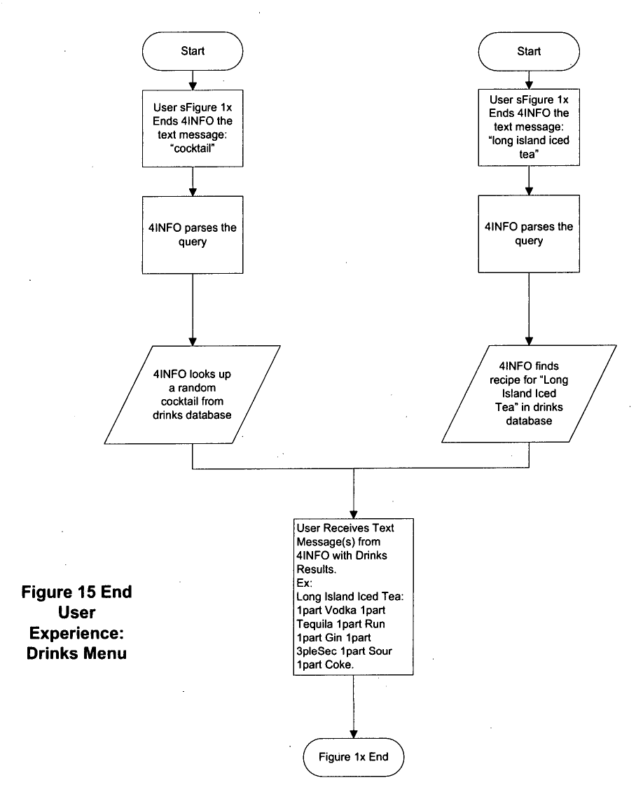

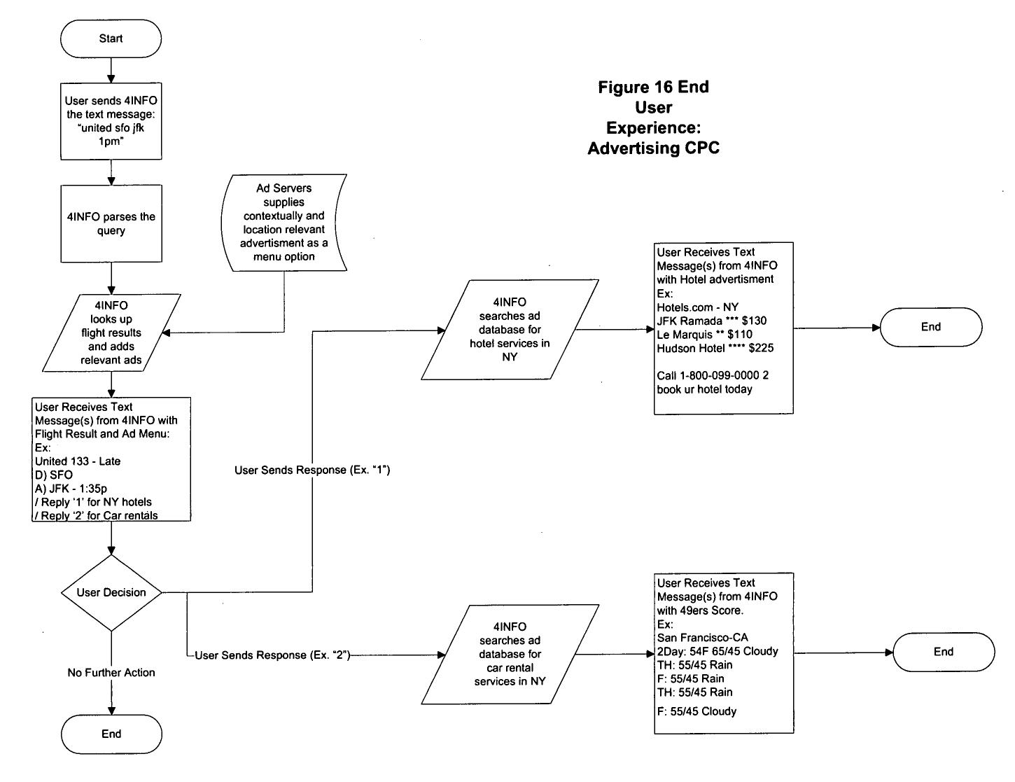

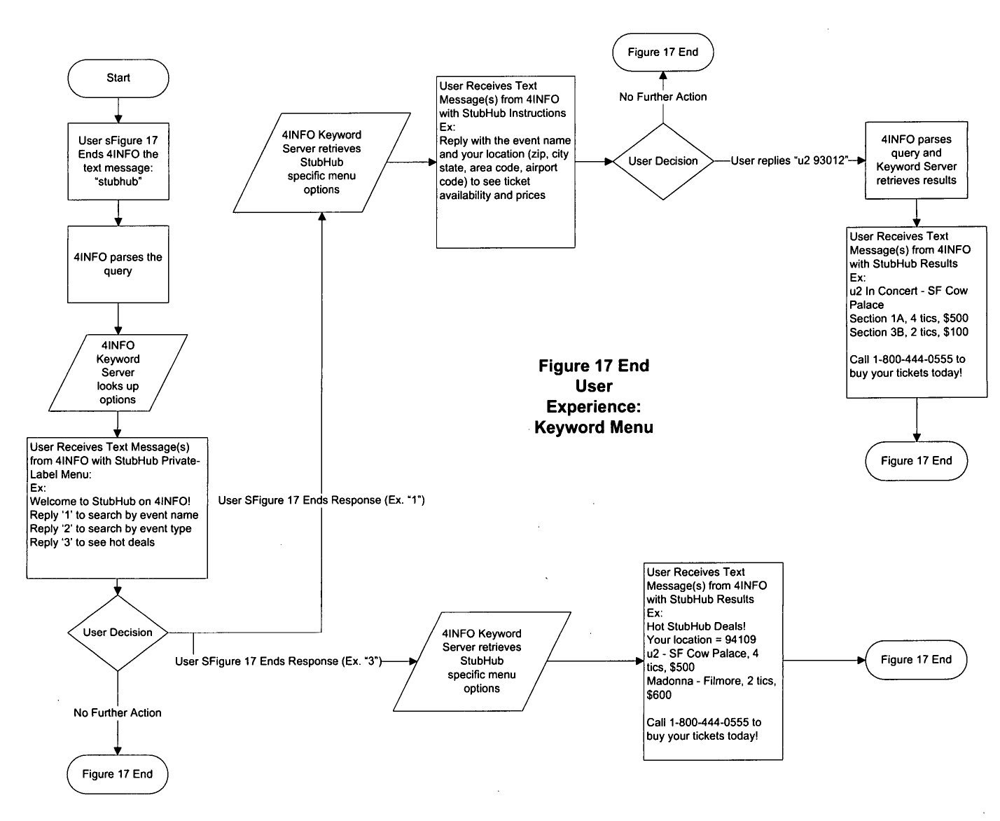

The flowcharts of FIGS. 15-19 provide examples of embodiments of the invention, each example illustrating the use of an embodiment of the invention to obtain a different type of information. It will be appreciated from review of the drawings that the flowcharts are not intended to fully describe the functionality of the specific embodiments, but are intended to show how elements of the invention could be combined together to create a system that delivers a desired user experience. Further, the information services referenced in these examples are provided as representatives of the plurality of information services that could be used by the invention to return targeted information to users. Finally, the primary form of interaction in these end user examples is SMS (text messaging) and it will be appreciated that SMS is highlighted to simplify description of the examples.

End User Example: Movies

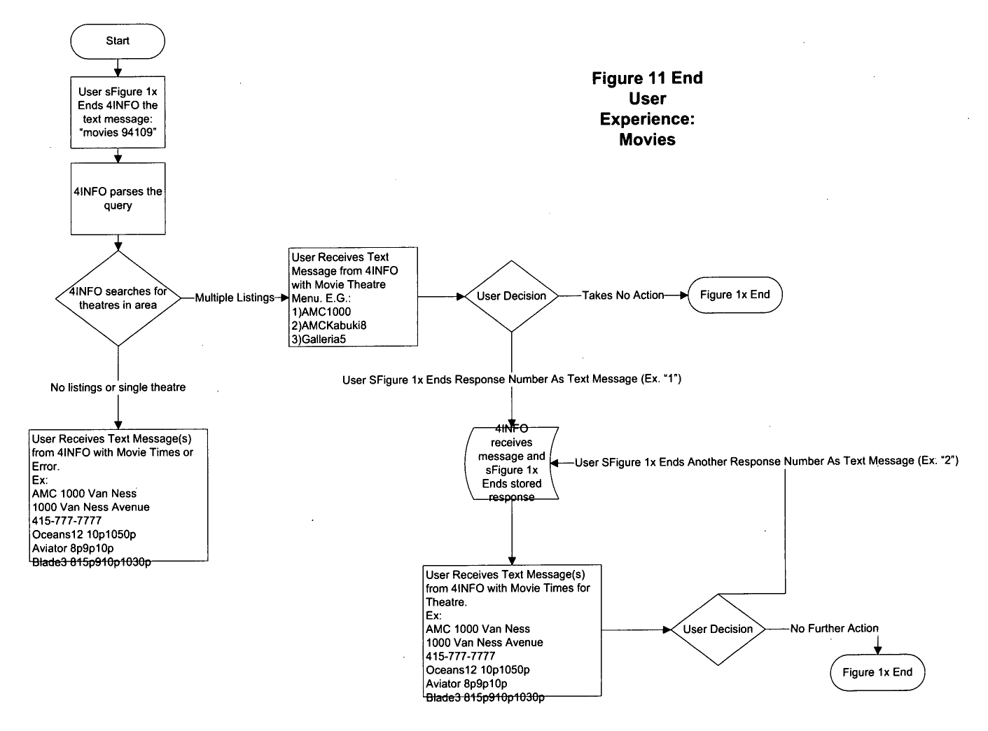

FIG. 11 provides a flowchart that illustrates the operation of one example of a system that handles a typical incoming movie-related query and dynamically provides responses based on temporal and content related issues. In this example, the user sends a text message with the message body “movies 94109” to the 4INFO System. The 4INFO System then parses the query and determines that it is a query for the movie theatres in and around the 94109 zip code. The Service Results manager queries the Movies Information Service and returns all the show times at movie theatres in that region. If the information is short enough to fit into a predefined number of text messages (2 in this case), 4INFO returns that information to the user. This is an example of where dynamic results can have a huge impact on the system. Because the movies service discards show times for movies that have already played that day, users that search late in the day will get far different results from users that search earlier in the day. If there is too much information to fit into the predefined number of messages, the 4INFO System returns an interactive menu that presents the users with options to get additional information. In this case, to select a theatre for which the user wishes to see show times. The user can then either take no action, in which case the 4INFO System does nothing, or can choose to reply with the number of the movie theatre they wish to see show times for. The 4INFO System then receives this message and the Interactive Reply Menu cache returns the stored response for that theatre. The user receives this as a text message and can either continue to send replies to the system for additional information about other theatres or can take no further action.

End User Example: Flights

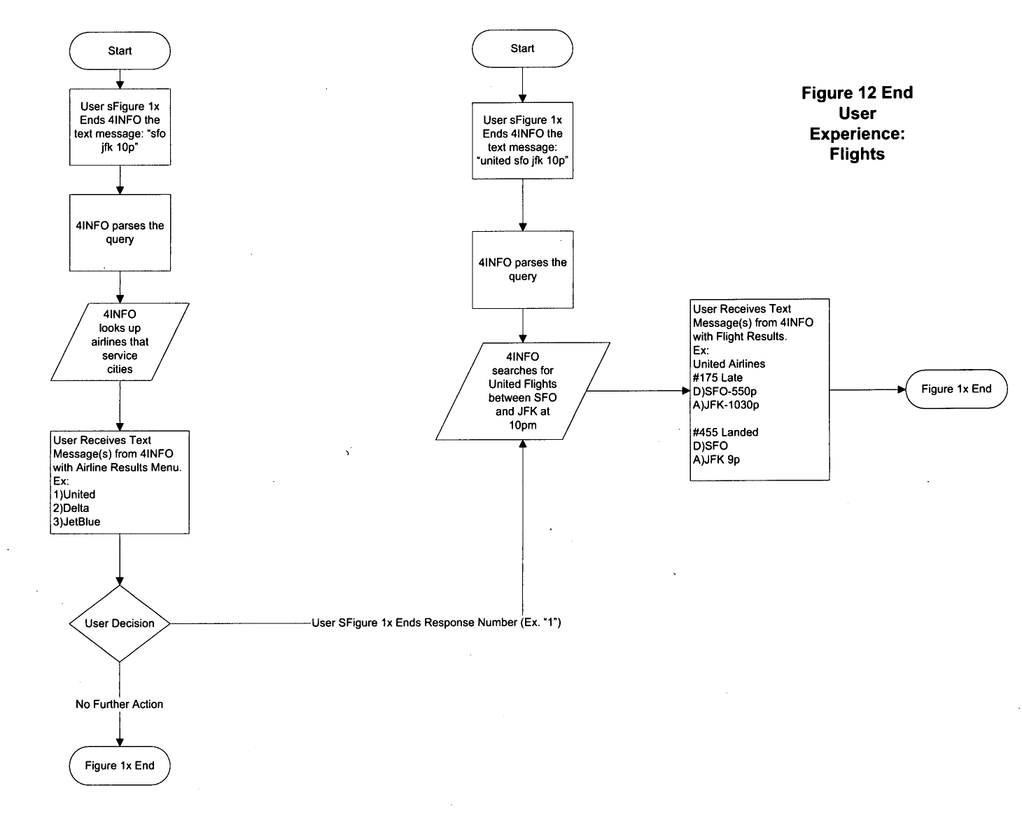

FIG. 12 provides a flowchart that illustrates the operation of an example of a system for handling a typical incoming travel-related query and dynamically provides responses based on temporal and content related issues.

End User Example: Sports

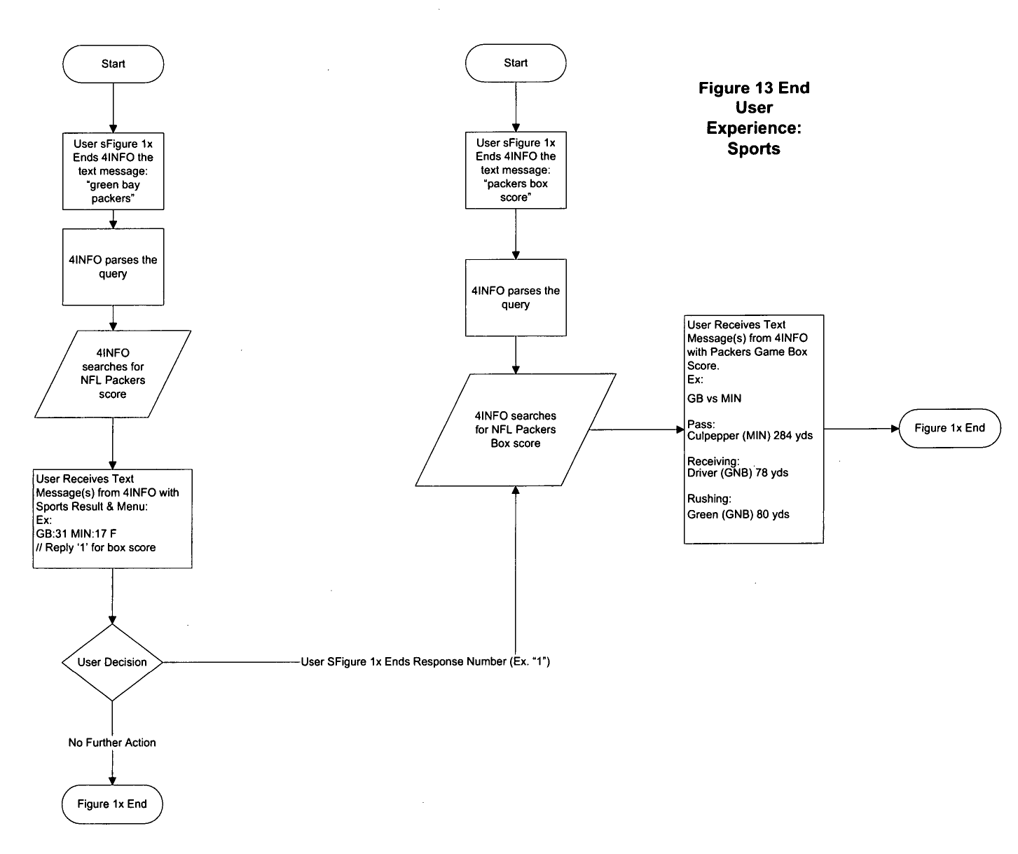

FIG. 13 provides a flowchart that illustrates the operation of an example of a system for handling a typical incoming Sports-related query and dynamically provides responses based on temporal and content related issues.

End User Example: City Lookup

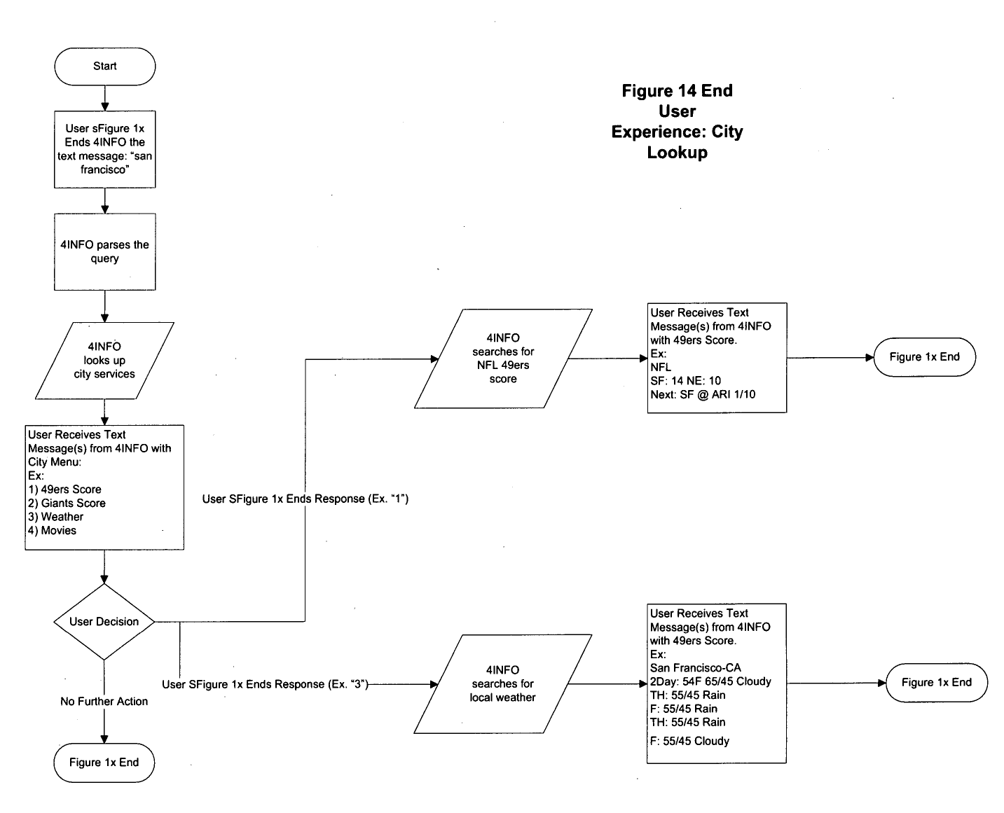

FIG. 14 provides a flowchart that illustrates the operation of an example of a system for handling a typical incoming city-specific query and dynamically provides responses based on temporal and content related issues.

End User Example: Drinks

FIG. 15 provides a flowchart that illustrates the operation of an example of a system for handling a typical incoming “nightlife-related” query and dynamically provides responses based on temporal and content related issues.

End User Example: Advertising 1

FIG. 15 provides a flowchart that illustrates the operation of an example of a system for providing advertising content related to incoming queries. The example demonstrates how the Ad Server dynamically creates advertising that is relevant to context and location information derived from a user query and the user's prior system usage.

Aspects of the Invention as Described Above Include:

Embodiments provide a system and method for processing queries such that keywords can be extracted from a message, specific meaning can be derived from the message based on attributes associated with the message, and a response to the message can be provided that presents results of searches based on the keywords and optimized by the specific meanings. In some embodiments, the results contain content from information sources identified as best-fit search result. In some embodiments, the response comprises a menu having options identifying plural high probability search results. In some certain embodiments, the attributes include attributes associated with a user, including location-based information, user preferences and prior activities of the user. In certain embodiments, the attributes include time of day, day of week, seasonal and date information. In certain embodiments, a user can be connected to an information service identified in the search results. In certain embodiments, a user can be connected to a transactional system based on the search results. In certain embodiments, advertising, marketing and help information can be provided to a user based on the search results. In certain embodiments, advertising, marketing and help information can be targeted to a user based on user attributes including a history of prior activity. In certain of these embodiments, advertising, marketing and help information can be transmitted to the user using an alerts system.

Although the present invention has been particularly described with reference to embodiments thereof, it should be readily apparent to those of ordinary skill in the art that changes and modifications in the form and details thereof may be made without departing from the spirit and scope of the invention. For example, those skilled in the art will understand that variations can be made in the number and arrangement of components illustrated in the above block diagrams. It is intended that the appended claims include such changes and modifications.

1. A method for processing queries comprising:
extracting one or more keywords from a message;
obtaining attributes associated with the message;
deriving specific meanings for selected ones of the one or more keywords; and
providing a response of a search based on the keywords and optimized by the specific meanings.

2. The method of claim 1, wherein the response comprises content of a target identified as a best-fit search result.

3. The method of claim 1, wherein the response comprises a menu having two options.

4. The method of claim 1, wherein the attributes include locational attributes.

5. The method of claim 4, wherein the locational attributes include geographic location identifiers corresponding to the source of the messsage.

6. The method of claim 4 wherein the attributes include a history of prior interactions.

7. The method of claim 1 wherein the specific meanings are derived based on a context indicated by the attributes.

8. The method of claim 7 wherein the context includes attributes associated with a user, the attributes including locational information and a history of prior queries.

9. The method of claim 1, wherein the attributes include predefined shortcuts.

10. The method of claim 1, wherein the attributes include user-defined shortcuts.

11. The method of claim 1, and further comprising:
selectively delivering a menu to a user, and
responsive to receiving a second message, providing a second response to the user.

12. The method of claim 11, wherein the second response includes connecting the user to one or more information services.

13. The method of claim 11, wherein the second response includes connecting the user to a transaction system.

14. The method of claim 1 wherein the message is received from a mobile device and wherein the attributes include identifying attributes associated with a source of the message.

15. A method for text messsage processing
receiving a text message from a user;
assigning specific meanings to keywords in the text message;
associating the keywords with corresponding query terms; and
providing a response based on the query terms.

16. A method according to claim 15 wherein the keywords are associated with specific query terms based on a history of messages.

17. A method according to claim 15 the keywords are associated with specific query terms based on predetermined definitions provided by the user.

18. A method according to claim 15 wherein the response includes a menu, and further comprising:
receiving a second message text message from the user,
identifying a desired query term from the second text message; and
storing the desired query term.

19. A method according to claim 15 wherein the keywords are associated with specific query terms based on locational information.

20. A method according to claim 19 wherein the locational information includes a current geographical location of the user.

21. A method according to claim 19 wherein the locational information includes a geographical location selected by the user.

22. A method according to claim 19 wherein the locational information includes one or more area codes.

23. A system for processing short queries comprising:
a pre-processor for generating a query from one or more keywords in the message and attributes associated with the message and a user;
a probability engine for predicting results of searches based on the query; and
a results analyzer for maintaining a history of queries and results and for maintaining lexicons, grammars and the attributes.

24. The system of claim 23, and further comprising a formatter for providing a response to a user, the response comprising content of a target identified as a best-fit search result.

25. The system of claim 23, wherein the response comprises a menu having two or more options.

26. The system of claim 23, wherein the attributes include locational attributes.

27. The system of claim 26, wherein the locational attributes include geographic location indentifies corresponding to the source of the message.

28. The system of claim 23 wherein the attributes include a history of prior interactions.

29. The system of claim 23 wherein the specific meanings are derived based on a context indicated by the attributes.

30. The system of claim 29 wherein the context includes attributes associated with a user, the attributes including locational information and a history of prior queries.

31. The system of claim 23, wherein the attributes include predefined shortcuts.

32. The system of claim 23, wherein the attributes include user-defined shortcuts.

33. The system of claim 23 wherein the message is received from a mobile device and wherein the attributes include identifying attributes associated with a source of the message.

34. The system of claim 33 wherein the message is received as one or more SMS text messages.

35. The system of claim 23, and further comprising a user profiler for maintaining the attributes.

36. The system of claim 35, wherein the attributes are supplemented using heuristic methods based on a user profile.

37. The system of claim 23 and further comprising an alerts system for creating information alerts for the users, wherein the alerts include status change alerts and periodic alerts.

38. The system of claim 37, wherein the alerts are generated based on a query submitted by the user.

39. The system of claim 23 and further comprising an ad server for optimizing advertising messages in a search result based on factors including a profile of the user, context of the search result and capabilities of a device identified to receive the search result.
